(19) United States
(12) Patent Application Publication
(10) Pub. No.: US 2006/0096102 A1
(43) Pub. Date: May 11, 2006

(54) Method and apparatus for securing a handle to a knife tang

(76) Inventors: Les DeAsis, West Linn, OR (US); Bruce Robert Troyan, Lake Oswego, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/198,493

(22) Filed: Aug. 5, 2005

Related U.S. Application Data
(63) Continuation of application No. 10/418,889, filed on Apr. 18, 2003.
(60) Provisional application No. 60/373,774, filed on Apr. 18, 2002.

(51) Int. Cl. B25G 3/00

(52) U.S. Cl. 30/342

(57) ABSTRACT

The present invention relates to knives and related implements, and, more particularly, to methods and apparatus for attaching a handle to a tang of a knife. One aspect of the invention is for attaching a handle to a tang of a knife by removably coupling an insert having a threaded bore onto a portion of the tang, the insert being adapted to couple with a coupler, the coupler comprising a threaded rod and an expanded head, such as, but not limited to, a bolt. The engagement of the insert and the coupler pulls together the tang and the handle in removably coupling engagement.

### RELATED APPLICATIONS

This application claims the benefit of U.S. Provisional Application No. 60/373,774, filed Apr. 18, 2002.

### FIELD OF THE INVENTION

The present invention relates to knives and related implements, and, more particularly, to methods and apparatus for removably coupling a handle to a tang of a knife.

### BACKGROUND OF INVENTION

Knives and related implements, such as rifle bayonets and swords, are commonly constructed from an elongated metal blade having a cutting portion at one end and a tang at the opposite end upon which a handle is coupled. The handle is used as a grip for the hand of the user. There are a variety of methods of attaching the handle and ancillary components to the tang, including, but not limited to, the use of rivets, cast in place, and the use of threaded fasteners.

One method of handle attachment known in the art provides a tang that is threaded to accept a nut. The handle is slipped over the tang and the nut is advanced onto the tang to secure the handle between the cutting portion and the nut. The threads on the tang can be provided in a number of ways, such as, by welding a threaded rod to the end of the tang, and direct machining of the threads into the tang. Providing a threaded tang to facilitate handle attachment adds manufacturing steps to the knife fabrication process, which adds to the cost and time of manufacture.

Welding a threaded rod to the tang is not a preferred method as it not only adds to the manufacturing time and cost, but can weaken the metal blade causing cracking and failure. Heat treatment is commonly used to establish a material property favorable to the longevity of the cutting portion, but may not be suitable for threaded engagement which requires a relatively softer material property. The heat of welding will change the material property of the blade in undesirable ways which could lead to failure.

A knife used for military applications is required to have one or more specific characteristics. One characteristic is for the knife to be convertible from a handheld knife to a rifle bayonet. One way to accommodate this conversion is to have a handle coupling means that is amendable to disassembly and assembly in the field. Another characteristic is for the knife to accommodate and be interchangeable with the attachment of various handle pieces and ancillary components. For example, but not limited thereto, the knife may be required to have a removable finger guard between the cutting portion and the handle to be replaced with a rifle bracket to convert the knife to a bayonet.

Military specifications commonly require that the knife be functional, yet inexpensive. Therefore, specialized welding or other processes have proven expensive to meet the military supply specification as well as market competition. Further, the knife is required to be adapted for field use that requires, for example, ease of assembly/disassembly, interchangeability with other components in response to changing functionality, and be cost effective.

Therefore, apparatus and methods are needed that provide knives and similar implements that are relatively easy to assemble and disassemble the handle and ancillary components from the blade, and are not economically prohibitive to manufacture.

### BRIEF DESCRIPTION OF DRAWINGS

FIGS. 1 and 2 are side and top views, respectively, of a knife in accordance with an embodiment of the present invention;

FIGS. 3 and 4 are top and side longitudinal cross-sectional views about lines 3-3 and 4-4, respectively, of the embodiment of the knife of FIGS. 1 and 2, respectively;

FIG. 5 is a perspective view of one of two scales of a two piece handle, in accordance with an embodiment of the present invention;

FIGS. 6A and 6B are exploded and assembled perspective views, respectively, of the blade showing the tang, insert and the coupler, in accordance with an embodiment of the present invention; and

FIGS. 7, 8 and 9 are plan, side and perspective longitudinal cross-sectional views, respectively, of a knife including ancillary components in accordance with an embodiment of the present invention.

### DESCRIPTION

In the following detailed description, reference is made to the accompanying drawings which form a part hereof wherein like numerals designate like parts throughout, and in which is shown by way of illustration specific embodiments in which the present invention may be practiced. It is to be understood that other embodiments may be utilized and structural or logical changes may be made without departing from the scope of the present invention. Therefore, the following detailed description is not to be taken in a limiting sense, and the scope of the present invention is defined by the appended claims and their equivalents.

The present invention relates to knives and related implements, and, more particularly, to methods and apparatus for removably coupling a handle to a tang of a knife. In accordance with an embodiment of the present invention, methods and apparatus are provided for removably coupling a handle to a tang of a knife by removably coupling an insert having a threaded bore, such as, but not limited to, a nut, onto the tang, the insert adapted to removably couple with a coupler, the coupler comprising a threaded rod and an expanded head, such as, but not limited to, a bolt. The engagement of the insert and the coupler pulls together the tang and the handle in removably coupling engagement.

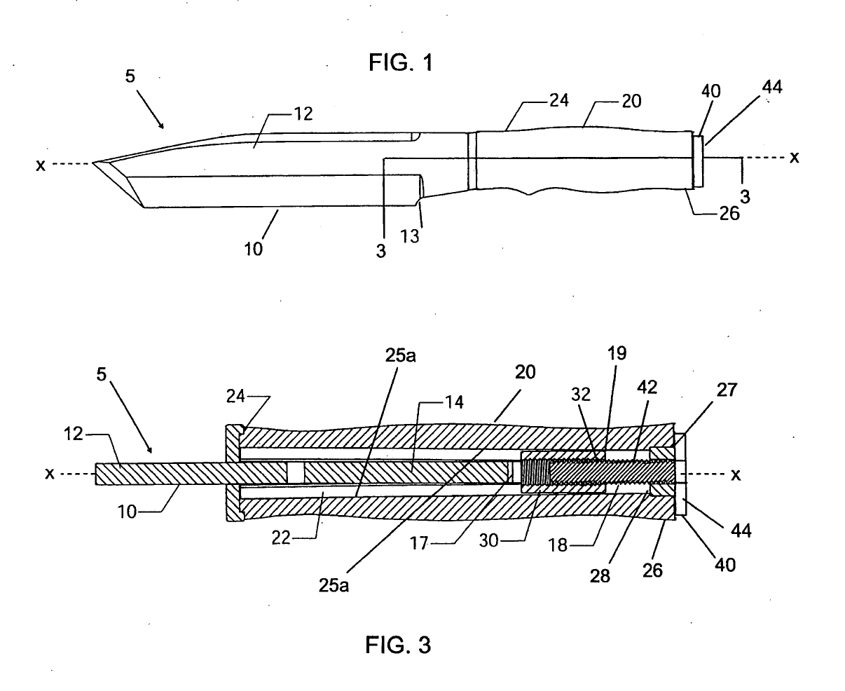

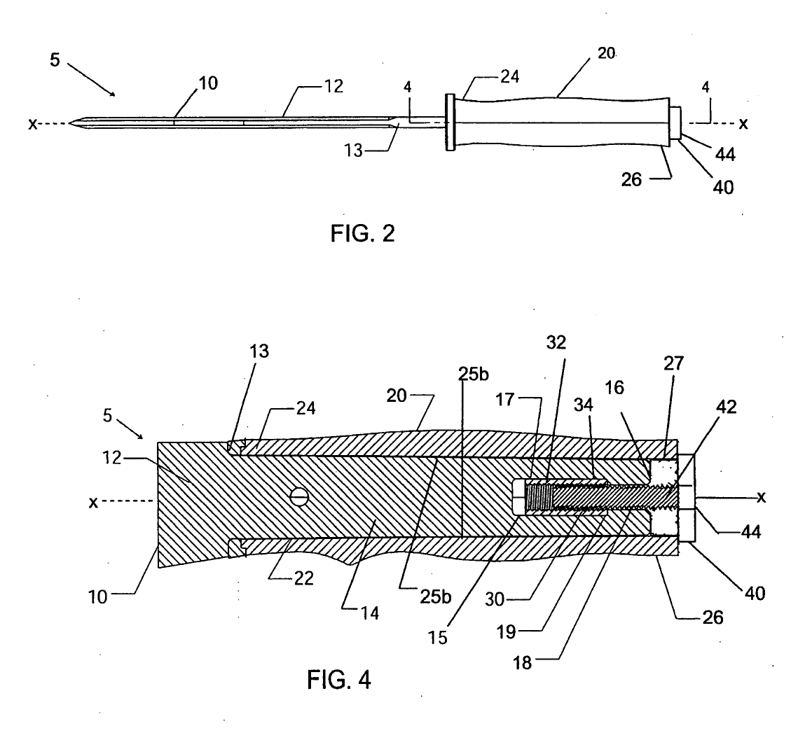

FIGS. 1 and 2 are side and top views, respectively, of a knife 5 in accordance with an embodiment of the present invention. FIGS. 3 and 4 are top and side longitudinal cross-sectional views about lines 3-3 and 4-4, respectively, of the knife 5 as shown in FIGS. 1 and 2, respectively. The knife 5 comprises a blade 10, a handle 20, an insert 30, and a coupler 40. The coupler 40, in cooperation with the insert 30, couples the handle 20 to the blade 10. The insert 30 is engaged by the blade 10 and retained therein, in part, by the handle 20. The coupler 40 is adapted to threadably engage the insert 30 to removably couple the handle 20 to the blade 10. When assembled, the blade 10 is at least partially contained within the handle 20 and at least partially extended from the handle 20.

The blade 10 has an elongated, substantially planar form, comprising a cutting portion 12 at one end, a tang 14 at an opposite end, and a blade shoulder 13 there between. The tang 14 has a substantially planar, rectangular form which extends substantially linearly along a longitudinal axis x-x from the blade shoulder 13 to a terminal end 16. The blade 10 comprises a material suitable for a particular purpose, such as, but not limited to, carbon steel, stainless steel, other metals and metal alloys, composites and plastics. The blade 10 is fabricated by a variety of known methods, including, but not limited to, forming, casting, machining, stamping, and cutting by laser or mechanical means from a blank of suitable material.

The handle 20 is an elongated member comprising a cavity 22 there through which extends substantially coaxial with the longitudinal axis x-x. The cavity 22 is adapted to accept at least a portion of the tang 14, but not the cutting portion 12 or blade shoulder 13, therein. The handle 20 comprises a tang receiving end 24 and a butt end 26 opposite the tang receiving end 24. During assembly, the tang 14 is slidably received and advanced into the cavity 22 at the tang receiving end 24. The butt end 26 has a butt end aperture 27 adapted to receive a portion of the coupler 40, as discussed below. The handle 20 comprises any material suitable for a particular purpose, such as, but not limited to, metal, composite, plastic, and wood.

The cavity 22 is adapted to facilitate the placement of the tang 14 therein. The shape of the cavity 22 is predetermined for a particular handle 20 to tang 14 cooperative engagement. A number of handle 20 to tang 14 cooperative engagement embodiments are anticipated. For example, but not limited thereto, in one embodiment the handle 20 to tang 14 cooperative engagement relies primarily on the tang 14 and/or the insert 30 being wedgedly engaged by tapered cavity walls 25a, 25b, as will be discussed below. In another example, but not limited thereto, in another embodiment the handle 20 to tang 14 cooperative engagement relies primarily on the engagement of the blade shoulder 13 and the tang receiving end 24 of the handle, as will be discussed below.

In an embodiment in accordance with the present invention, as shown in FIG. 3, the cavity 22 comprises cavity walls 25a, 25b, at least one of wish has an inward taper towards the butt end 26 such that the tang 14 engages the cavity walls 25a, 25b, as in a wedge, as the tang 14 is driven into the cavity 22 during assembly, effectively removably coupling the handle 20 to the tang 14.

In another embodiment, not shown, in accordance with the present invention, the cavity 22 comprises cavity walls 25a, 25b, at least one of wish has an inward taper towards the butt end 26 such that the insert 30 engages the cavity walls 25a, 25b, as in a wedge, as the tang 14 is driven into the cavity 22 during assembly, effectively removably coupling the handle 20 to the tang 14.

In another embodiment in accordance with the present invention, as shown in FIG. 4, the blade 10 comprises shoulders 13 adjacent the tang 14, wherein the tang receiving end 24 of the handle 20 abuts the shoulders 13 as the tang 14 is drawn into the cavity 22. The terminal end 16 of the tang 14 does not come into abutment with either the coupler 40 or portions of the handle 20 to ensure that the terminal end 16 does not hinder the advancement of the tang 14 into the cavity 22 to effect the engagement of the tang receiving end 24 with the blade shoulders 13, capturing and/or placing the handle 20 in compression, effectively removably coupling the handle 20 to the tang 14.

In yet another embodiment in accordance with the present invention, not shown, the terminal end 16 abuts the coupler 40 to capture and/of put the handle 20 into a compressed state between the blade shoulders 13 and the coupler 40, preventing the over tightening of the coupler 40.

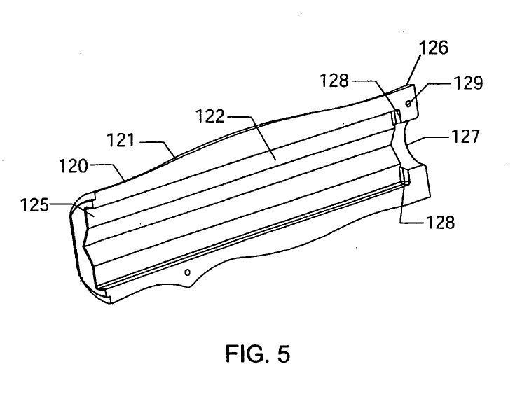

The handle 20 as shown in FIG. 4 is of a one piece construction. FIG. 5 is a perspective view of one of two half-handle pieces, known in the art as scales 121, of a two piece handle 120, in accordance with another embodiment of the present invention. Alignment features 129 are provided to guide the assembly and provide alignment of the two scales 121. The scales 121 comprise a cavity 122 adapted to accept the tang 14 and insert 30 when the scales 121 are brought together to surround the tang 14.

It is anticipated that other handle designs are suitable for a particular purpose in accordance with embodiments of the present invention. For example, but not limited thereto, the handle comprises a plurality of axial sections or rings, wherein, when advanced side-by-side onto the tang 14, forms the complete handle. One or more axial sections are interchangeable with other sections having features suitable for a particular purpose, or interchanged with other components, such as, but not limited to, a finger guard and a rifle bracket.

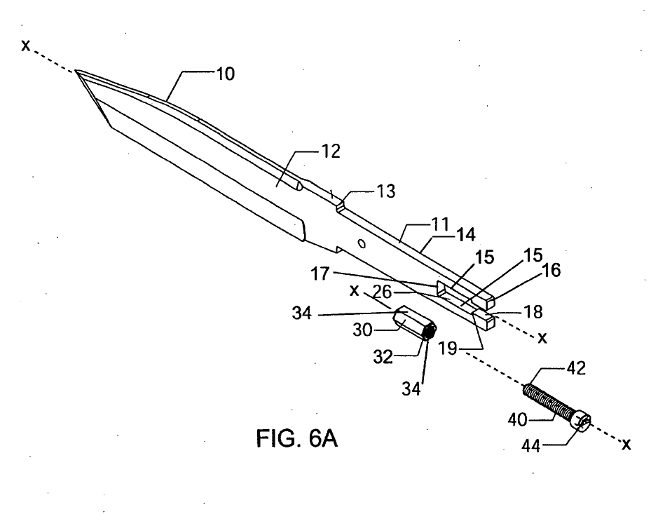

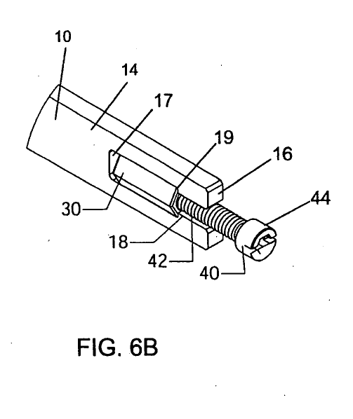

FIGS. 6A and 6B are exploded and assembled perspective views, respectively, of the blade 10 showing the tang 14, insert 30 and the coupler 40, without the handle 20 to simplify the view. The tang 14 further comprises an insert aperture 17 in communication with a coupler aperture 18 extending from the terminal end 16. The insert aperture 17 and coupler aperture 18 comprise a through slot in the tang 14, and are adapted to receive the insert 30 and at least a portion of the coupler 40, respectively. The coupler aperture 18 has a dimension that is smaller than the insert aperture 17 defining an aperture shoulder 19 there between. The aperture shoulder 19 is adapted to prevent the insert 30 from entering the coupling aperture 18 upon assembly. The coupler aperture 18 is adapted to provide an opening between the insert aperture 17 and the terminal end 16 to slidably receive a portion of the coupler 40 as discussed below.

The insert 30 comprises a threaded through bore 32 that extends substantially linearly along the longitudinal axis x-x. In accordance with another embodiment of the present invention, the threaded bore 42 of the insert 30 extends at least a predetermined distance into the insert 30 and is adapted to accept a portion of the coupler 40 without the coupler 40 bottoming out in the bore 32.

The insert 30 has a predetermined outer dimension adapted for cooperative engagement with the insert aperture 17. Upon assembly, the insert aperture 17 is adapted to slidably receive the insert 30. The engagement of the insert aperture 17 and the insert 30 substantially prevents rotation of the insert 30 about the longitudinal axis x-x caused by the torque of the coupler 40 during assembly.

The insert 30 is adapted to be retained by the insert aperture 17 with the bore 32 of the insert 30 in substantial coaxial alignment with the longitudinal axis x-x and therefor the coupler aperture 18, such that the coupler 40 can threadably engage the bore 16 from the terminal end 16 through the coupler aperture 18.

In an embodiment in accordance with the present invention, the insert 30 comprises parallel insert sides 34 adapted for cooperative engagement with complimentary parallel aperture sides 15 of the insert aperture 17. The parallel insert sides 34 and aperture sides 15 provide for sliding engagement, as well as a “keying” function that guides the insert 30 into the insert aperture 17 in a predetermined orientation and is substantially constrained to that orientation by the close engagement of the insert sides 34 and aperture sides 15.

The insert 30 shown in FIG. 6A has a hexagon form, such as provided by, but not limited to, a hex nut, with three pairs of parallel sides 34, one or more of which is adapted to slidably engage the insert aperture 17. Other forms of the insert 30 is anticipated, such as, but not limited to, rectangular, square, and other forms having at least two flat sides 34. In another embodiment in accordance with the present invention, the insert 30 is cylindrical in form, though the alignment of the bore 32 with the coupler aperture 18 is more challenging.

The coupler 40 is adapted to threadably engage the bore 32 of the insert 30 while also engaging the butt end 26 of the handle 20 to couple the handle 20 to the tang 14. In an embodiment in accordance with the present invention, the coupler 40 comprises a threaded rod 42 and a head 44. The head 44 is adapted to provide specific retention needs suitable for a particular purpose. In the embodiment of FIG. 4, the head 44 has a predetermined dimension adapted to abut the butt end 26 of the handle 20 when assembled. In other embodiments in accordance with the present invention, the head 44 has a predetermined dimension that is larger than the diameter of the coupler aperture 18, preventing advancement of the head 44 into the coupler aperture 18.

Upon assembly, the insert 30 is received into the insert aperture 17 such that the bore 32 of the insert 30 is in coaxial alignment with the longitudinal axis x-x and therefore, in alignment with the coupler aperture 18 of the tang 14 and the butt end aperture 27 of the handle 20. The rod 42 of the coupler 40, as shown in FIG. 4, is adapted to pass through the butt end aperture 27 and the coupler aperture 18 to threadably engage the bore 32 of the insert 30, as shown in FIG. 4.

In an embodiment in accordance with the present invention wherein the handle 20 is a one-piece design, the tang 14 is adapted to be slidably received into the cavity 22 of the handle 20 at the tang receiving end 24. The cavity 22 is adapted to substantially conform to the form of the insert 30/tang 14 assembly.

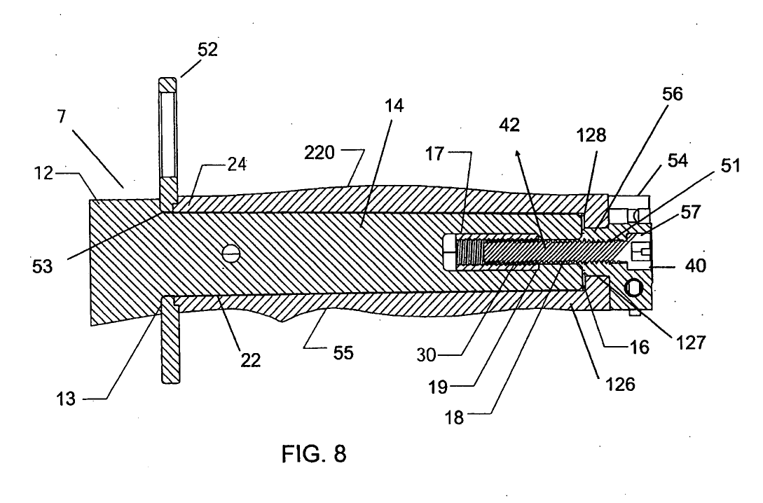

The specific engagement condition between the cavity 22 and the tang 14/insert 30 when assembled is predetermined for a particular purpose. As previously discussed, in the embodiment of FIG. 3, the cavity 22 comprises inwardly tapered sides 25a that taper from the tang receiving end 24 to the butt end 26. The tapered sides 25a are adapted such that as the tang 14 is drawn into the cavity 22 by the threaded engagement of the rod 42 of the coupler 40 with the bore 32 of the insert 30, the insert 30 comes into urging engagement with the cavity sides 25a. The tang 14 has a predetermined length adapted such that the tang terminal end 16 does not come into abutment with the head 44 as shown in FIG. 4, or the cavity shoulder 128 of another embodiment as shown in FIG. 8. Whereas the tang terminal end 16 does come into abutment with the head 44 or the cavity shoulder 128, the blade 10 will no longer be drawn into the handle 20, potentially resulting in the handle 20 being captured onto the tang 14 in a loose coupled condition about the tang 14.

The tapered sides 23 also assist in restricting the rotation of the tang 14 during assembly, in particular, if the cavity 22 does not sufficiently conform to the form of the tang 14. Other “keying” methods may be used such that the tang 14 and handle 20 cooperate to prevent rotation of the tang 14 within the cavity 22 during assembly and disassembly, such as provided by the cavity sides 125, as shown in FIG. 5, that substantially conform to the rectangular form of the tang 14 and provide clearance for the insert 30.

In an embodiment in accordance with the present invention, not shown, the cavity 22 is inwardly tapered from the tang receiving end 24 to the butt end 26. As the tang 14 is drawn into the cavity 22 by the threaded engagement of the rod 42 with the bore 32, the tang sides 11, as shown in FIG. 6A, comes into urging engagement with the cavity sides 25b. Similarly, as in the embodiment above, the tang 14 has a predetermined length adapted such that the tang terminal end 16 does not come into abutment with the head 44 as shown in FIG. 4, or the cavity shoulder 128 as shown in FIG. 8.

In accordance with an embodiment of the method of the present invention, the knife 5 is assembled by slidingly engaging the insert 30 into the insert aperture 17 of the tang 14 such that the bore 32 of the insert 30 is substantially in coaxial alignment with the longitudinal axis x-x, and therefore, aligned with the coupler aperture 18 of the tang 14 and the butt end aperture 27 of the handle 20. The tang 14 is slidingly inserted into the tang receiving end 24 of the one-piece handle 20, or surrounded by the assembled scales 121 of the multi-piece handle 120. The rod 42 of the coupler 40 is slidingly received through the butt end aperture 27 of the handle 20 and the coupler aperture 18 of the tang 14, to threadably engage the bore 32 of the insert 30, as shown in FIG. 4. In the case of the multi-piece handle 120, the rod 42 of the coupler 40 is slidingly received through the butt end aperture 127 of the handle 120 and the coupler aperture 18 of the tang 14, to threadably engage the bore 32 of the insert 30.

The threaded rod 42 is advanced into the bore 32 of the insert 30 causing the head 44 to come into urging engagement with the handle butt end 26, as well as the insert 30 to come into urging engagement with the aperture shoulder 19. Further advancement of the coupler 40 draws the tang 14 further into the cavity 22 towards the butt end 26. A portion of the tang 14 and/or the insert 30 is driven against the tapered sides 25a, 25b of the cavity 22 in urging engagement, effectively removably coupling the handle 20 to the tang 14.

In accordance with another embodiment of the present invention, the length of the tang 14 has a predetermined length adapted such that the tang terminal end 16 does not come into contact with the cavity shoulder 33 or the head 44 during assembly. The tang 14 is further adapted such that the tang 14 does not come into urging engagement with the cavity sides 25a, 25b. The length of the tang 14 is adapted such that the blade shoulders 13 come into abutment and/or urging engagement with the tang receiving end 24 of the handle 20, as well as the head 44 to come into abutment and/or urging engagement with the butt end 26. The handle 20 is thus captured and/or put into a compressed state by the tension between the coupler 40 and the blade 10, effectively removably coupling the handle 20 to the tang 14.

In accordance with an embodiment of the method of the present invention, the knife 5 is assembled by advancing the insert 30 into the insert aperture 17 of the tang 14 such that the bore 32 is in substantial coaxial alignment with the longitudinal axis x-x of the blade 10. The tang 14 is inserted into the tang receiving end 24 of the handle 20. The rod 42 of the coupler 40 is slidingly received through the butt end aperture 27 of the handle 20 and the coupler aperture 18 of the tang 14, to threadably engage the bore 32 of the insert 30. The rod 42 is threadably engaged into the bore 32 of the insert 30 to cause the head 44 to urge against the butt end 26 of the handle 20, as well as the insert 30 to urge against the aperture shoulder 19. Further advancement of the coupler 40 draws the tang 14 further into the cavity 22 towards the butt end 26 until the blade shoulders 13 abut the tang receiving end 24 of the handle 20 in urging engagement, effectively removably coupling the handle 20 to the tang 14.

The knife 5 is adapted to be disassembled by advancing the rod 42 out of the bore 32, the coupler aperture 18, and the butt end aperture 27, and slidingly removing the handle 20 from the tang 14, and slidingly removing the insert 30 from the insert aperture 17. The ease of disassembly provides for the replacement of the components of the knife 5, for example, but not limited to, the replacement of a damaged insert 30. Further, the knife 5 is adapted to be disassembled and reassembled to provide for the attachment and interchangeability of ancillary components, as discussed below.

A desired feature, often required for military applications, is the coupling of ancillary components onto the knife 5. Ancillary components include, but are not limited to, a finger guard, hand guard, and rifle bracket, that are coupled to the blade 10 positioned between the blade shoulder 13 and the handle 20. Other ancillary components, including, but not limited to, a latch assembly and butt end protector, are coupled to the knife 5 positioned at the butt end 26 of the handle 20. The removable coupling features of embodiments of the present invention provide for assembly and interchangeability of single or combinations of ancillary components onto the knife 5.

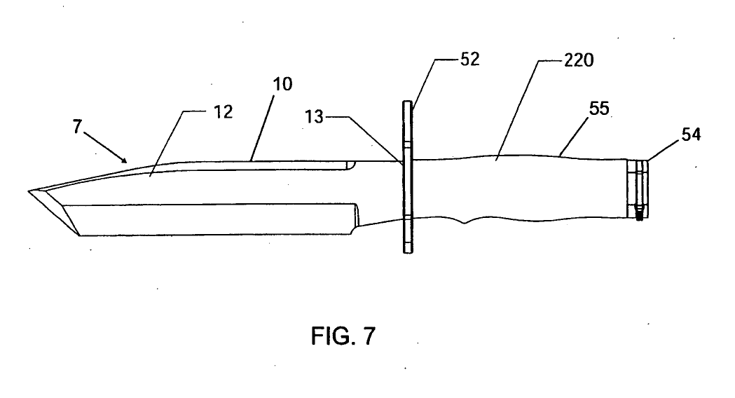

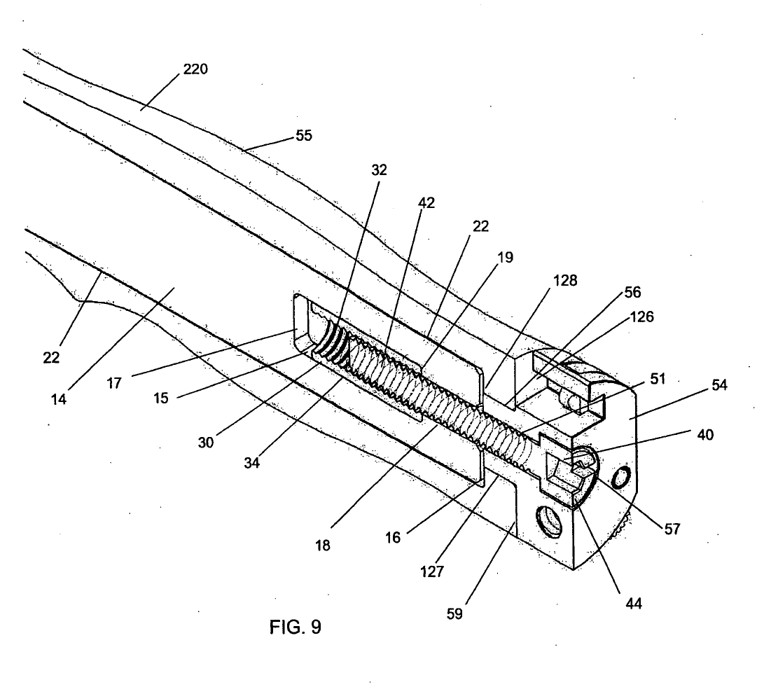

FIGS. 7, 8 and 9 are plan, side and perspective longitudinal cross-sectional views, respectively, of a knife 7 in accordance with an embodiment of the present invention. The knife 7 further comprises a rifle bracket 52, such as associated with a bayonet, coupled on the blade 10 between the blade shoulder 13 and the handle 220. The rifle bracket 52 comprises a bracket aperture 53 which is adapted to slidingly engage the tang 14 and be advanced to abut the blade shoulder 13 prior to handle 220 assembly. The rifle bracket 52 is secured to the blade 10 upon engagement of the coupler 40 with the insert 30 and the butt end 126, in urging engagement between the blade shoulder 13 and the tang receiving end 24.

In accordance with another embodiment of the present invention, a finger guard (not shown) is adapted to couple with the blade 10 in substantially similar arrangement as the rifle bracket 52 described above. The knife 7, therefore, is adapted for the interchangeability of ancillary components, such as, but not limited to, the finger guard with the rifle bracket 52.

In accordance with an embodiment of the present invention, a latch assembly 54 is adapted to be assembled adjacent the butt end 26 of the handle 220 and coupled by the engagement of the coupler 40 with the insert 30 and the latch assembly 54. The latch assembly 54 comprises a bushing 56 adapted to be slidably received into the butt end aperture 127. The latch assembly 54 further comprises a latch aperture 51 adapted to slidingly receive the rod 42 of the coupler 40, such that the head 44 comes into urging engagement with and secures the latch assembly 54 to the butt end 126 as the rod 42 engages the bore 32. The latch assembly 54 further comprises a countersink recess 57 adapted to receive therein the head 44, wherein once engaged with the insert 30, the head 44 is flush with or recessed within the latch assembly 54.

In accordance with another embodiment of the present invention, a butt cap (not shown) is adapted to couple with the blade 10 in substantially similar arrangement as the latch assembly 54 above. The butt cap is adapted to provide the bushing 56 and the countersink recess 57 in similar form as the latch assembly 54. The butt cap provides protection for the butt end 126 as well as the esthetic appeal of a countersunk head 44.

It is noted that should the insert 30 become damaged in any way during assembly/disassembly of the knife 5, the insert 30 is easily removed from the insert aperture 17 with no appreciable detrimental affect on the tang 14. Thereafter, a new insert 30 is inserted within the insert aperture 17 in accordance with embodiments of the present invention.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the art will readily appreciate that the present invention may be implemented in a very wide variety of embodiments. This application is intended to cover any adaptations or variations of the embodiments discussed herein.

1.-25. (canceled)

26. A fixed blade knife comprising:
a) a blade and tang piece wherein said blade and tang extend from an integral junction to respective terminal ends along a first longitudinal axis;
b) a handle piece having a second longitudinal axis, distal and proximal ends, and a through, longitudinal opening, said opening having a first portion of keyhold shape, with a cylindrical central portion and rectangular portions on opposite sides, extending into said distal end for a first portion of the length of said handle piece, and a second portion of cylindrical shape extending into said proximal end to adjoin said keyhole shape;
c) a slot extending into said terminal end of said tang substantially along said axis, said slot having a first portion extending from said terminal end for a first distance having a first width, ad a second portion extending from said first portion for a second distance having a second width,
d) a nut having a threaded bore with a central axis, and an external surface having two opposite sides formed in a cylindrical plane and two opposite, planar surfaces spaced by a distance equal to or slightly smaller than said second width of said tang slot said nut having an axial length less than said second distance; and
e) a screw having a threaded portion for engagement with said bore and a head portion having a maximum cross-dimension larger than the diameter of said second portion of said handle opening.

27. The knife of claim 26 wherein said first and second longitudinal axes are substantially coaxial.

28. The knife of claim 26 wherein said nut has an axial length which is at least 90% of said second distance of said slot.

29. The knife of claim 26 wherein said second portion of said handle portion through opening includes a first section of diameter equal to or slightly larger than the diameter of said screw threaded portion, and a second section of diameter larger than said maximum cross-dimension of said screw head portion, said first section extending from said first portion of said handle portion through opening to merge with said second section and said second section extending from said first section to said proximal end of said handle piece.

30. The knife of claim 26 wherein said tang has a predetermined, uniform thickness and said planar surfaces of said nut have widths at least as great as said thickness.

31. The knife of claim 26 wherein said tang has an axial length which is at least 90% of said first portion of the length of said handle piece.

32. The knife of claim 31 wherein said tang has an axial length which is substantially as great as said first portion of the length of said handle piece.

33. The knife of claim 32 wherein said blade is wider than said tang at the junction thereof, forming a pair of stepped shoulders limiting the extent of axial advance of said tang into said handle through opening.

34. The method of fabricating and assembling a fixed blade knife comprising:
a) forming an integral blade and tang extending along a common, first longitudinal axis from a mutual junction to respective terminal ends;
b) forming a slot extending into said tang terminal end, said slot having first and second portions with a common, first central axis extending linearly parallel to said first longitudinal axis, said first portion extending from an open end at said tang terminal end to a first junction with said second portion, and said second portion extending from said first junction to a closed end, said first and second portions having respective first and second, minimum widths at said first junction, said second width being larger than said first width;
c) forming a handle having proximal and distal ends, and a cavity extending from a first open end at said distal end to a second junction with a bore extending from said second junction to a second open end at said proximal end, said bore having a second central axis;
d) forming a nut having a threaded bore with a second longitudinal axis, a first cross dimension slightly less than said second width, allowing said first threaded fastener to be moved laterally into said second portion of said slot, and a second cross dimension perpendicular to said first cross dimension and larger than said second width;
e) placing said nut in said second portion of said slot with said second longitudinal axis coaxial with said first central axis;
f) advancing said tang terminal end, with said nut positioned in said second portion of said slot, into said first open end of said cavity until said tang terminal end reaches said second junction with said second longitudinal axis coaxial with said second central axis;
g) inserting a screw having external threads matable with said threaded bore into said second open end of said cavity; and
h) advancing said screw through said cavity bore to engage said threaded bore and tightening said screw.

35. The method of claim 34 and further comprising forming said bore with a first portion extending from said second junction to a second portion which extends to said handle proximal end, said first and second bore portions having respective first and second diameters, said second diameter being larger than said first diameter.

36. The method of claim 35 wherein said screw has a threaded stem portion having a diameter not more than said first diameter, and a head portion having a maximum cross dimension not more than said second diameter, whereby said stem portion may be advanced through said first bore portion while said head portion remains in said second bore portion.

37. The method of claim 36 wherein said second bore portion and said head portion have substantially equal axial lengths, whereby said head portion is substantially flush with said proximal end of said handle when said stem is fully engaged with said threaded bore.

38. The method of claim 34 wherein each of said first and second portions of said slot have substantially constant widths over their respective axial lengths.

39. The method of claim 38 wherein said nut has an axial length slightly less than the axial length of said first slot portion.

40. The method of claim 39 wherein the axial length of said first slot portion is less than one-half the axial length of said second slot portion.

41. The method of claim 34 wherein said tang portion has an axial length substantially equal to the axial length of said first cavity portion.

42. The method of claim 41 wherein said first slot portion has a substantially constant cross sectional outline throughout its axial length, said outline conforming substantially to the cross sectional outline of said tang portion with said nut located in said first slot portion.
